(19) United States
(12) Patent Application Publication
(10) Pub. No.: US 2024/0417053 A1
(43) Pub. Date: Dec. 19, 2024

(54) AIRSHIP

(71) Applicant: Idealab Studio, LLC, Pasadena, CA (US)

(72) Inventors: Andrea Pedretti, Thousand Oaks, CA (US); Mauro Pedretti-Rodi, Canobbio (CH)

(21) Appl. No.: 18/739,958

(22) Filed: Jun. 11, 2024

Related U.S. Application Data
(60) Provisional application No. 63/508,611, filed on Jun. 16, 2023.

(51) Int. Cl. B64B 1/08

(52) U.S. Cl. CPC B64B 1/08

(57) ABSTRACT

An airship includes an inflatable membrane, an upper beam attached to an outer surface of an upper end of the inflatable membrane, and a lower beam attached to an outer surface of a lower end of the inflatable membrane. When the inflatable membrane is inflated with a gas less dense than air (e.g. helium, hydrogen), the gas in a cavity of the membrane vertically separates the upper beam from the lower beam along at least a portion of their lengths. A payload carried by the airship applies a tension force on the upper beam and a compression force on the lower beam.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to an airship, and more particularly to an airship having a lightweight structure.

### Description of the Related Art

Existing airships require a rigid truss or frame inside the inflatable structure of the airship, adding to the complexity and weight of the airship.

### SUMMARY

Accordingly, there is a need for improved, simplified and lighter airship design that excludes a rigid frame inside the inflatable membrane of the airship.

In accordance with one aspect of the disclosure, an airship is provided that includes an inflatable membrane, a beam extending along a bottom of the inflatable membrane from a proximal end to a distal end of the inflatable membrane, and a second beam or cable extending along a top of the inflatable membrane from the proximal end to the distal end of the inflatable member.

In accordance with another aspect of the disclosure, an airship is provided. The airship comprises an inflatable membrane. The airship also comprises an upper beam attached to an outer surface of an upper end of the inflatable membrane, and a lower beam attached to an outer surface of a lower end of the inflatable membrane. When the inflatable membrane is inflated with a gas less dense than air (e.g., helium, hydrogen), the gas in a cavity of the membrane vertically separates the upper beam from the lower beam along at least a portion of their lengths, and wherein a payload carried by the airship applies a tension force on the upper beam and a compression force on the lower beam.

In some aspects, the techniques described herein relate to an airship, wherein the upper beam is a cable.

In some aspects, the techniques described herein relate to an airship, wherein the upper beam is a cable made of carbon fiber.

In some aspects, the techniques described herein relate to an airship, further including a tension element extending between the upper beam and the lower beam.

In some aspects, the techniques described herein relate to an airship, wherein the tension element is a plurality of tension elements that extend vertically between the upper beam and the lower beam in a direction perpendicular to a centerline of the membrane.

In some aspects, the techniques described herein relate to an airship, wherein the tension element includes a second plurality of tension elements that extend between the upper beam and the lower beam at a non-perpendicular and non-parallel angle relative to a centerline of the membrane.

In some aspects, the techniques described herein relate to an airship, wherein the second plurality of tension elements extend to a center of the lower beam.

In some aspects, the techniques described herein relate to an airship, wherein the upper beam is a pair of spaced apart upper beams and the lower beam is a pair of spaced apart lower beams.

In some aspects, the techniques described herein relate to an airship, further including tension elements extending between the upper beams and the lower beams that are vertically aligned with each other.

In some aspects, the techniques described herein relate to an airship, further including tension elements extending between the upper beams and the lower beams that are vertically offset from each other.

In some aspects, the techniques described herein relate to an airship, wherein the upper beam is four spaced apart upper beams and the lower beam is four spaced apart lower beams.

In some aspects, the techniques described herein relate to an airship, further including tension elements extending between the upper beams and the lower beams that are vertically aligned with each other.

In some aspects, the techniques described herein relate to an airship, further including tension elements extending between the upper beams and the lower beams that are vertically offset from each other.

In some aspects, the techniques described herein relate to an airship, including: an inflatable membrane; an upper beam attached to an outer surface of an upper end of the inflatable membrane; a lower beam attached to an outer surface of a lower end of the inflatable membrane; and a load support structure attached to the lower beam configured to carry a load, wherein when the inflatable membrane is inflated with a gas less dense than air, the gas in a cavity of the membrane vertically separates the upper beam from the lower beam along at least a portion of their lengths, and wherein a payload carried by the airship applies a tension force on the upper beam and a compression force on the lower beam.

In some aspects, the techniques described herein relate to an airship, wherein the upper beam is a cable made of carbon fiber.

In some aspects, the techniques described herein relate to an airship, further including one or more tension elements extending between the upper beam and the lower beam in a direction perpendicular to a centerline of the membrane.

In some aspects, the techniques described herein relate to an airship, wherein the one or more tension elements includes a plurality of tension elements that extend between the upper beam and the lower beam at a non-perpendicular and non-parallel angle relative to a centerline of the membrane.

In some aspects, the techniques described herein relate to an airship, wherein the plurality of tension elements extend to a center of the lower beam.

In some aspects, the techniques described herein relate to an airship, wherein the load support structure includes a pair of outer angled beams extending between and connecting ends of the lower beam and a cross-beam via a pair of joints.

In some aspects, the techniques described herein relate to an airship, further including a pair of inner angled beams extending between and connecting an intermediate portion of the lower beam and the cross-beam via the pair of joints.

In some aspects, the techniques described herein relate to an airship, wherein the joints are slidable to facilitate centering of the load relative to the lower beam, the upper beam and the inflatable membrane.

### BRIEF DESCRIPTION OF THE DRAWINGS

FIG. 1 is a schematic perspective view of an airship.

FIG. 2 is a schematic cross-sectional view of the airship in FIG. 1 along its length along line B-B in FIG. 1.

FIG. 3 is a schematic cross-sectional view of the airship in FIG. 1 across its width along line A-A in FIG. 1.

FIG. 4 is a schematic side view of a modified airship of FIG. 2.

FIG. 5A is a schematic cross-sectional view of an airship across its width.

FIG. 5B is a schematic cross-sectional view of the airship of FIG. 5A across its length.

FIG. 6 is a schematic cross-sectional view of an airship along its length.

FIG. 7 is a schematic cross-sectional view of an airship across its width.

FIG. 8 is a schematic cross-sectional view of an airship across its width.

FIG. 9 is a schematic cross-sectional view of an airship along its length.

### DETAILED DESCRIPTION

Disclosed below is an airship with a simplified structural design that results in an airship with reduced weight compared to existing airship designs. The airship can be used (e.g., operated) to transport cargo or goods (e.g., lumber, steel, motors) between locations that are difficult or impossible to reach using other transportation means (e.g., trains, automobiles, ships).

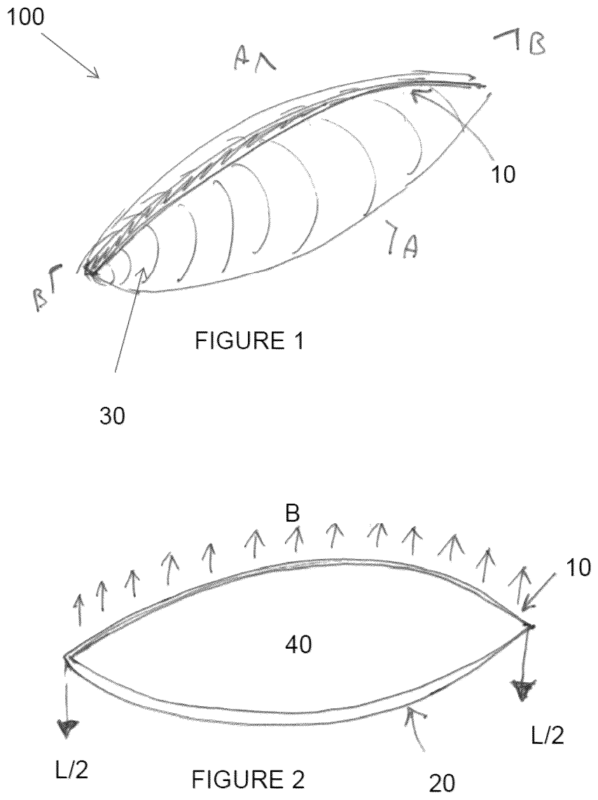

FIGS. 1-3 show an airship 100. The airship 100 has an upper beam 10 (e.g., has a single upper beam 10), a lower beam 20 (e.g., has a single lower beam 20) and an inflatable membrane 30 that extends between and is coupled to the upper beam 10 and the lower beam 20 (e.g., the load bearing structure of the airship 100 is defined by or consists of a single upper beam 10, a single lower beam 20 and the inflatable membrane 30). That is, the upper beam 10 and the lower beam 20 are attached to (e.g., adhered to) an outer surface of the membrane 30.

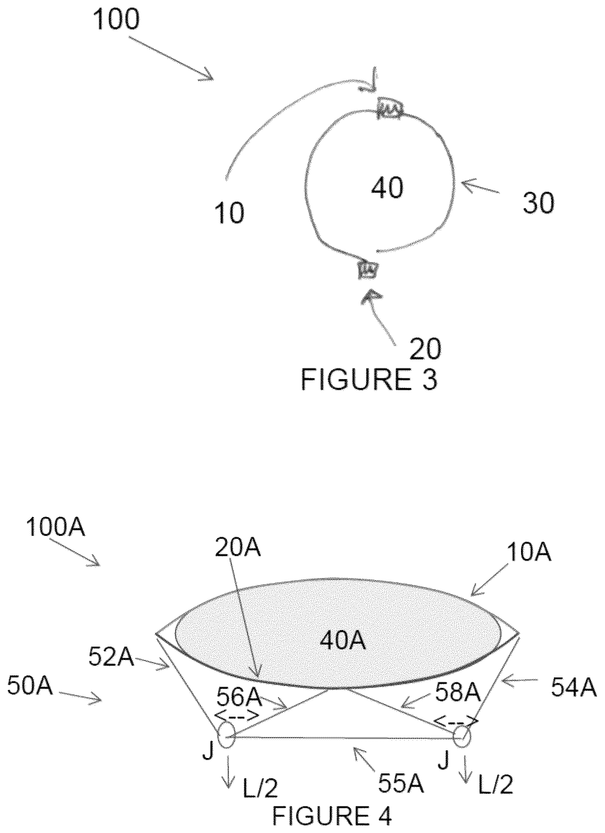

In one implementation, the inflatable membrane 30 is coupled to the upper beam 10 and/or lower beam 20 at spaced apart intervals along the length of the upper beam 10 and/or lower beam 20. In another implementation, the inflatable membrane 30 is coupled to the upper beam 10 and/or lower beam 20 along an entire length of the upper beam 10 and/or the lower beam 20. In one example, the membrane 30 can couple to the upper beam 10 and/or the lower beam 20 via an adhesive. When inflated, the membrane 30 advantageously facilitates (e.g. maintains) the upper beam 10 and/or the lower beam 20 straight. In one implementation, the upper beam 10 can be a cable (e.g., carbon fiber cable). In one implementation, the upper beam 10 and/or the lower beam 20 can be hollow along its length. The inflatable membrane 30, once inflated, can have a longitudinal cross-section (along lines B-B) that is generally oval in shape, as shown in FIG. 2, and have a generally circular widthwise cross-section (along line A-A), as shown in FIG. 3. The inflatable membrane 30 can have a cavity 40 that is inflated with a gas that is less dense than air, such as helium or hydrogen, so that the airship 100 can float or rise in air, allowing the airship 100 to fly, the gas applying a buoyancy force B on the airship 100 (e.g., along an entire length of the membrane 30, along an entire length of the upper beam 10). The membrane 30, when inflated, separates the upper beam 10 from the lower beam 20 (e.g., the gas in the membrane separates the upper beam 10 from the lower beam 20). In one implementation, the airship 100 can have a length of between about 100 m and about 200 m, such as about 150 m, and can have a height (when fully inflated) of between about 25 m and about 75 m, such as about 50 m.

With continued reference to FIGS. 1-3, the upper beam 10 can have a relatively small cross-section relative to the widthwise cross-section of the inflatable membrane 30 (see FIG. 3). In one implementation, the upper beam 10 and/or lower beam 20 can have a cross-section transverse to its length that is rectangular and hollow. In one implementation, the upper beam 10 and/or the lower beam 20 can have a transverse cross-section of about between about 400-600 mm by about 200-300 mm and have a thickness of between about 3 mm and about 6 mm, such as about 4 mm. The ends of the upper beam 10 and the ends of the lower beam 20 can contact each other. In one implementation, the ends of the lower beam 20 can be coupled to corresponding ends of the upper beam 20. When the airship 100 carries a payload L, each end of the airship 100 will be subjected to ½ of the payload (e.g., L/2). Advantageously, the payload L applies a compression force on the lower beam 20 and applies a tension force on the upper beam 10. In one implementation, the upper beam 10 and/or the lower beam 20 can be made of a lightweight metal, such as aluminum. In another implementation, since only a tensile force is exerted on the upper beam 10, the upper beam 10 can be made of a material (e.g., carbon fiber) that has a high tensile strength.

FIG. 4 shows a lengthwise cross-section of an airship 100A. The airship 100A is similar to the airship 100 in FIGS. 1-3. Thus, reference numerals used to designate the various components of the airship 100A are identical to those used for identifying the corresponding components of the airship 100 in FIGS. 1-3, except that an “A” has been added to the end of the numerical identifier. Therefore, the structure and description (e.g., materials, dimensions) for the various features and components of the airship 100 and how they function or are operated and controlled in FIGS. 1-3 are understood to also apply to the corresponding features of the airship 100A in FIG. 4, except as described below.

The airship 100A differs from the airship 100 in that it includes a load support structure 50A attached to the lower beam 20A (e.g., at ends and a center portion of the lower beam 20A). The load support structure 50A can include two outer angled beams 52A, 54A that extend between ends of the lower beam 20A and connect to a cross-beam 55A via joints J. The load support structure 50A can also include inner angled beams 56A, 58A that extend between an intermediate portion of the lower beam 20A and couple to the cross-beam 55A via joints J. in one implementation, the joints J are slidable, allowing for adjustment of the load support structure 50A to facilitate centering of the load relative to the lower beam 20A and thereby relative to the upper beam 10A and the inflatable membrane 30A.

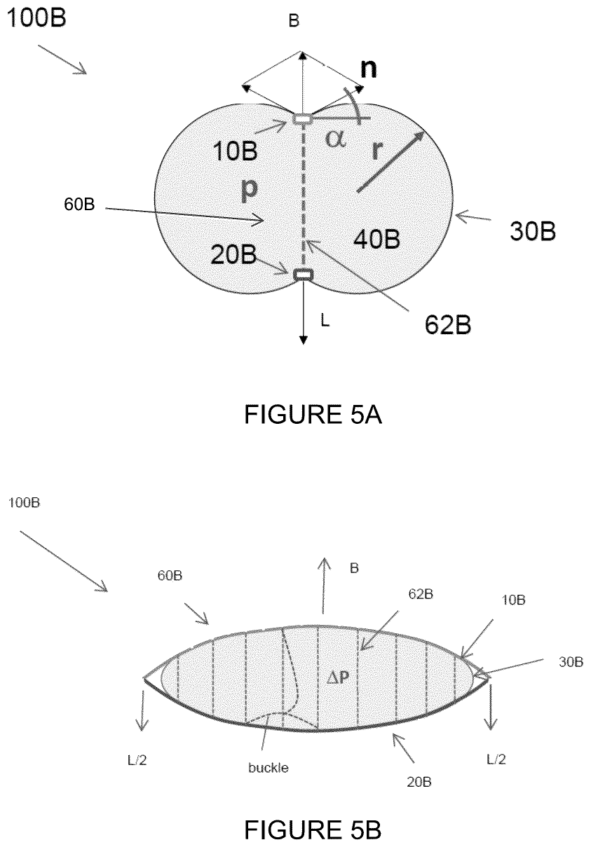

FIG. 5A shows a widthwise cross-section of an airship 100B and FIG. 5B shows a lengthwise cross-section of the airship 100B. The airship 100B is similar to the airship 100 in FIGS. 1-3. Thus, reference numerals used to designate the various components of the airship 100A are identical to those used for identifying the corresponding components of the airship 100 in FIGS. 1-3, except that a “B” has been added to the end of the numerical identifier. Therefore, the structure and description (e.g., materials, dimensions) for the various features and components of the airship 100 and how they function or are operated and controlled in FIGS. 1-3 are understood to also apply to the corresponding features of the airship 100B in FIGS. 5A-5B, except as described below.

The airship 100B differs from the airship 100 in that it includes an internal structure 60B within the membrane 30B. The internal structure 60B includes tension elements 62B, such as cables extending linearly (e.g., in a vertical direction, in a direction perpendicular to a centerline of the airship 100B along its length) between the upper beam 10B and the lower beam 20B. In one implementation, the tension elements 62B can be carbon fiber cables. In one implementation, the tension elements 62B can have a cross-sectional diameter of between about 8 mm and about 12 mm, such as about 10 mm. The tension elements 62B can be spaced from each other along the length of the airship 100B (e.g., spaced at regular intervals). As shown in FIG. 5A, the length of the tension elements 62B is smaller than a diameter of the membrane 30B when inflated if it did not have the tension elements 62B, resulting in the airship 100B having a double hollow bodies on either side of the upper beam 10B and the lower beam 20B, each hollow body having a greater than semi-circular cross-section (e.g., transverse to the length of the airship 100B) with a radius r. Each hollow body can be filled with a gas (e.g., helium, hydrogen) at a pressure p that allows the membrane 30B to float and/or rise in air. The membrane 30B can make an angle α with respect to a horizontal line extending through the upper beam 10B. The buoyancy force B applied on the airship 100B can be defined as B=2n sin(α)=p*r, where force n=pr and the angle α is approximately 30 degrees. The payload force L can be equal to or less than the buoyancy force B. As shown in FIG. 5B, the differential in pressure between the gas in the membrane 30B and atmospheric pressure will inhibit (e.g., prevent) the upper beam 10B (which is under tension) and the lower beam 20B (which is under compression) from buckling, providing for buckling-free compression of the lower beam 40B. If the lower beam 20B were to buckle, it could only buckle inwards (e.g., toward the cavity 40B).

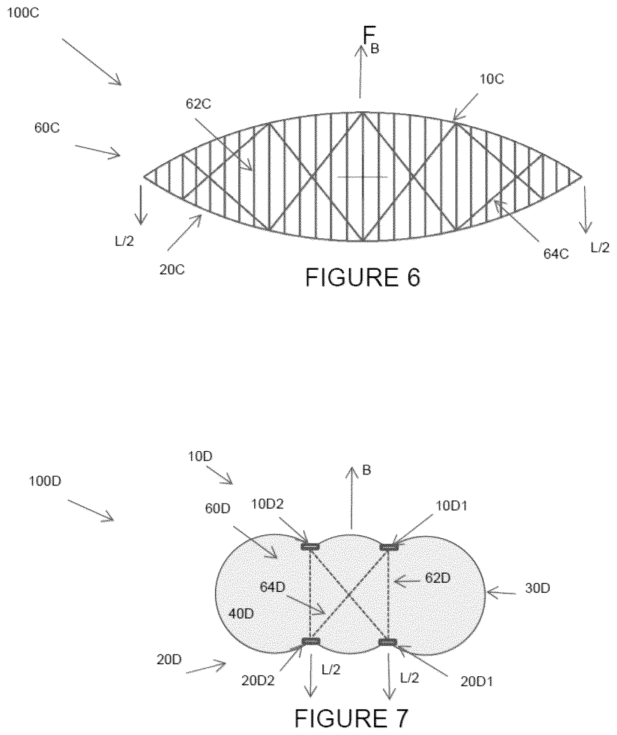

FIG. 6 shows a lengthwise cross-section of the airship 100C. The airship 100C is similar to the airship 100 in FIGS. 1-3. Thus, reference numerals used to designate the various components of the airship 100C are identical to those used for identifying the corresponding components of the airship 100 in FIGS. 1-3, except that a “C” has been added to the end of the numerical identifier. Therefore, the structure and description (e.g., materials, dimensions) for the various features and components of the airship 100 and how they function or are operated and controlled in FIGS. 1-3 are understood to also apply to the corresponding features of the airship 100C in FIG. 6, except as described below.

The airship 100C differs from the airship 100 in that it includes an internal structure 60C within the membrane (not shown). The internal structure 60C includes first tension elements 62C, such as cables extending linearly (e.g., in a vertical direction, in a direction perpendicular to a centerline of the airship 100C along its length) between the upper beam 10C and the lower beam 20C (e.g., spaced from each other, such as a regular intervals, along the length of the airship 100C). The internal structure 60C also includes second tension elements 64C that extend at an angle (e.g., at a non-perpendicular and non-parallel angle relative to a centerline of the airship 100C along its length) between the upper beam 10C and the lower beam 20C. The second tension elements 64C can contact each other. The first tension elements 62C and the second tension elements 64C can in one implementation be carbon fiber cables. In one implementation, the first tension elements 62C and the second tension elements 64C can have a diameter of between about 8 mm and about 12 mm, such as about 10 mm. As discussed previously, in one implementation the upper beam 10C and the lower beam 20C are hollow members made of aluminum. In one example, the weight of the upper beam 10C, the lower beam 20C and membrane 30C can total approximately 260 kN, and the membrane 30C can be filled with a gas (e.g., helium, hydrogen) that results in a pressure difference of 500 Pa and a buoyancy force at 5000 m of about 1325 kN, so that the airship 100C can carry a payload of about 1325 KN-260 kN or about 1065 kN.

FIG. 7 shows a widthwise cross-section of the airship 100D. The airship 100D is similar to the airship 100B in FIGS. 5A-5B. Thus, reference numerals used to designate the various components of the airship 100D are identical to those used for identifying the corresponding components of the airship 100B in FIGS. 5A-5B, except that a “D” instead of a “B” has been added to the end of the numerical identifier. Therefore, the structure and description (e.g., materials, dimensions) for the various features and components of the airship 100B and how they function or are operated and controlled in FIGS. 5A-5B are understood to also apply to the corresponding features of the airship 100D in FIG. 7, except as described below.

The airship 100D differs from the airship 100B in that it has two spaced apart upper beams 10D (e.g., upper beam 10D1 and upper beam 10D2) and has two spaced apart lower beams 20D (e.g., upper beam 20D1 and upper beam 20D2). The airship 100D has an internal structure 60D within the membrane 30D. The internal structure 60D includes tension elements 62D, such as cables extending linearly (e.g., in a vertical direction, in a direction perpendicular to a centerline of the airship 100D along its length) between the upper beams 10D and vertically aligned lower beams 20D. The internal structure 60D also has angled tension members 64D that extend between each lower beam 20D and an offset upper beam 10D. In one implementation, the tension elements 62D, 64D can be carbon fiber cables. In one implementation, the tension elements 62D, 64D can have a cross-sectional diameter of between about 8 mm and about 12 mm, such as about 10 mm. The tension elements 62D, 64D can be spaced from each other along the length of the airship 100D (e.g., spaced at regular intervals). The length of the tension elements 62D, 64D is such that when inflated the membrane 30D defines three hollow portions with a curved outer surface, the two outer hollow portions having a greater than semicircular cross-sectional shape (in a direction transverse to a length of the airship 100D). Each of the lower beams 20D (e.g., the lower beam 20D1, the lower beam 20D2) can carry ½ the payload weight or L/2.

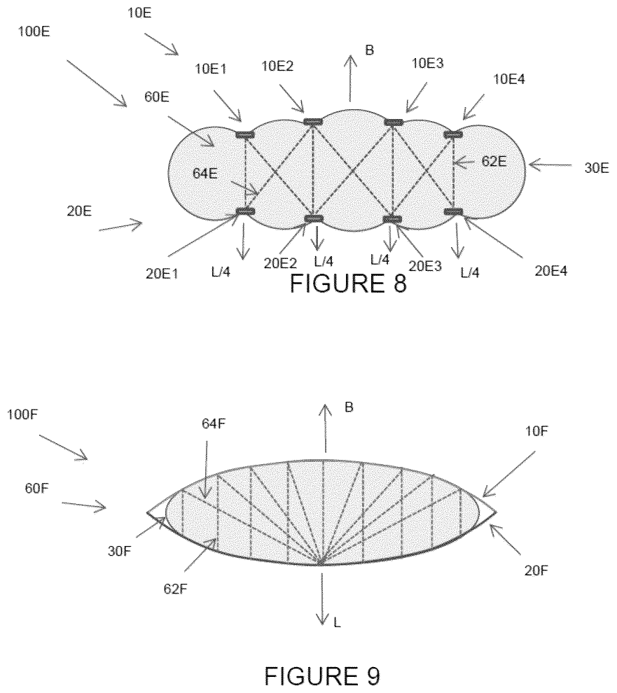

FIG. 8 shows a widthwise cross-section of the airship 100E. The airship 100E is similar to the airship 100B in FIGS. 5A-5B. Thus, reference numerals used to designate the various components of the airship 100E are identical to those used for identifying the corresponding components of the airship 100B in FIGS. 5A-5B, except that an “E” instead of a “B” has been added to the end of the numerical identifier. Therefore, the structure and description (e.g., materials, dimensions) for the various features and components of the airship 100B and how they function or are operated and controlled in FIGS. 5A-5B are understood to also apply to the corresponding features of the airship 100E in FIG. 8, except as described below.

The airship 100E differs from the airship 100B in that it has four spaced apart upper beams 10E (e.g., upper beams 10E1, 10E2, 10E3, 10E4) and has four spaced apart lower beams 20E (e.g., upper beams 20E1, 20E2, 20E3, 20E4). The airship 100E has an internal structure 60E within the membrane 30E. The internal structure 60E includes tension elements 62E, such as cables extending linearly (e.g., in a vertical direction, in a direction perpendicular to a centerline of the airship 100E along its length) between the upper beams 10E and vertically aligned lower beams 20E. The internal structure 60E also has angled tension members 64E that extend between each lower beam 20E and an offset upper beam 10E. In one implementation, the tension elements 62E, 64E can be carbon fiber cables. In one implementation, the tension elements 62E, 64E can have a cross-sectional diameter of between about 8 mm and about 12 mm, such as about 10 mm. The tension elements 62E, 64E can be spaced from each other along the length of the airship 100E (e.g., spaced at regular intervals). The length of the tension elements 62E, 64E is such that when inflated the membrane 30E defines five hollow portions with a curved outer surface, the two outer hollow portions having a greater than semicircular cross-sectional shape (in a direction transverse to a length of the airship 100E). Each of the lower beams 20E (e.g., the lower beams 20E1, 20E2, 20E3, 20E4) can carry ¼ the payload weight or L/4.

FIG. 9 shows a lengthwise cross-section of an airship 100F. The airship 100F is similar to the airship 100 in FIGS. 1-3. Thus, reference numerals used to designate the various components of the airship 100F are identical to those used for identifying the corresponding components of the airship 100 in FIGS. 1-3, except that an “F” has been added to the end of the numerical identifier. Therefore, the structure and description (e.g., materials, dimensions) for the various features and components of the airship 100 and how they function or are operated and controlled in FIGS. 1-3 are understood to also apply to the corresponding features of the airship 100F in FIG. 9, except as described below.

The airship 100F differs from the airship 100 in that it includes an internal structure 60F within the membrane 30F. The internal structure 60F includes tension elements 62F, such as cables extending linearly (e.g., in a vertical direction, in a direction perpendicular to a centerline of the airship 100F along its length) between the upper beam 10F and the lower beam 20F.

The internal structure 60F also has angled tension members 64F that extend at an angle between the top ends of the tension elements 62F at the upper beam 10F and a center portion of the lower beam 20F. In one implementation, the tension elements 62D, 64F can be carbon fiber cables. In one implementation, the tension elements 62F, 64F can have a cross-sectional diameter of between about 8 mm and about 12 mm, such as about 10 mm. The tension elements 62F, 64F can be spaced from each other along the length of the airship 100F (e.g., spaced at regular intervals). In the illustrated implementation, the center of the lower beam 20F carries the entire payload force L.

Advantageously, the airship described above (e.g., airship 100, 100A, 100B, 100C, 100D, 100E, 100F) has a lightweight structure that either excludes an internal support structure or where the internal support structure is made of only tension elements (e.g., cables, such as carbon fiber cables). The airship excludes a rigid internal frame, thereby reducing the complexity and weight of the airship, allowing the airship to carry heavier payloads since the upper beam, lower beam and membrane of the airship is lower than the structure of conventional airships that require an internal rigid truss structure.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. An airship, comprising:
an inflatable membrane;
an upper beam attached to an outer surface of an upper end of the inflatable membrane; and
a lower beam attached to an outer surface of a lower end of the inflatable membrane,
wherein when the inflatable membrane is inflated with a gas less dense than air, the gas in a cavity of the inflatable membrane vertically separates the upper beam from the lower beam along at least a portion of their lengths, and wherein a payload carried by the airship applies a tension force on the upper beam and a compression force on the lower beam.

2. The airship of claim 1, wherein the upper beam is a cable made of carbon fiber.

3. The airship of claim 1, further comprising a tension element extending between the upper beam and the lower beam.

4. The airship of claim 3, wherein the tension element is a plurality of tension elements that extend vertically between the upper beam and the lower beam in a direction perpendicular to a centerline of the inflatable membrane.

5. The airship of claim 4, wherein the tension element includes a second plurality of tension elements that extend between the upper beam and the lower beam at a non-perpendicular and non-parallel angle relative to a centerline of the inflatable membrane.

6. The airship of claim 5, wherein the second plurality of tension elements extend to a center of the lower beam.

7. The airship of claim 1, wherein the upper beam is a pair of spaced apart upper beams and the lower beam is a pair of spaced apart lower beams.

8. The airship of claim 7, further comprising tension elements extending between the upper beams and the lower beams that are vertically aligned with each other.

9. The airship of claim 8, further comprising tension elements extending between the upper beams and the lower beams that are vertically offset from each other.

10. The airship of claim 1, wherein the upper beam is four spaced apart upper beams and the lower beam is four spaced apart lower beams.

11. The airship of claim 10, further comprising tension elements extending between the upper beams and the lower beams that are vertically aligned with each other.

12. The airship of claim 11, further comprising tension elements extending between the upper beams and the lower beams that are vertically offset from each other.

13. An airship, comprising:
an inflatable membrane;
an upper beam attached to an outer surface of an upper end of the inflatable membrane;
a lower beam attached to an outer surface of a lower end of the inflatable membrane; and
a load support structure attached to the lower beam configured to carry a load,
wherein when the inflatable membrane is inflated with a gas less dense than air, the gas in a cavity of the inflatable membrane vertically separates the upper beam from the lower beam along at least a portion of their lengths, and wherein a payload carried by the airship applies a tension force on the upper beam and a compression force on the lower beam.

14. The airship of claim 13, wherein the upper beam is a cable made of carbon fiber.

15. The airship of claim 13, further comprising one or more tension elements extending between the upper beam and the lower beam in a direction perpendicular to a centerline of the inflatable membrane.

16. The airship of claim 15, wherein the one or more tension elements includes a plurality of tension elements that extend between the upper beam and the lower beam at a non-perpendicular and non-parallel angle relative to a centerline of the inflatable membrane.

17. The airship of claim 16, wherein the plurality of tension elements extend to a center of the lower beam.

18. The airship of claim 13, wherein the load support structure comprises a pair of outer angled beams extending between and connecting ends of the lower beam and a cross-beam via a pair of joints.

19. The airship of claim 18, further comprising a pair of inner angled beams extending between and connecting an intermediate portion of the lower beam and the cross-beam via the pair of joints.

20. The airship of claim 19, wherein the joints are slidable to facilitate centering of the load relative to the lower beam, the upper beam and the inflatable membrane.
